(19) United States
(12) Patent Application Publication
(10) Pub. No.: US 2007/0110409 A1
(43) Pub. Date: May 17, 2007

(54) Video display device with optical disc reproduction apparatus and television receiver with optical disc reproduction apparatus

(75) Inventor: Taku Yoshii, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/590,746

(22) Filed: Nov. 1, 2006

(30) Foreign Application Priority Data
Nov. 2, 2005 (JP) 2005-319223

(51) Int. Cl. H04N 5/00

(52) U.S. Cl. 386/126

(57) ABSTRACT

Disclosed is a television with DVD reproduction apparatus including optical disc reproduction apparatus that can reproduce video data and audio data recorded in DVD and audio data recorded in CD, Braun tube to display video corresponding to video data, and speaker to output audio corresponding to audio data. When optical disc loaded on optical disc reproduction apparatus is CD, switch is switched to OFF so as to cut off current supplied from power source to video display driving circuit, FBT, and Braun tube. Therefore, power consumption is suppressed by terminating Braun tube and the like that do not need to be operated when conducting reproduction processing of the CD.

### BACKGROUND OF THE INVENTION

1. Field of the Invention

The present invention relates to a video display device with optical disc reproduction apparatus and television receiver with optical disc reproduction apparatus.

2. Description of the Related Art

Conventionally, a television receiver with optical disc reproduction apparatus, in which an optical disc reproduction apparatus such as DVD player is integrated to a television receiver that receives a broadcast signal of a selected channel and outputs video and audio corresponding to the broadcast signal, has been known.

Further, concerning the television receiver with optical disc reproduction apparatus, a type that is capable to obtain video signal and audio signal by reproducing DVD (Digital Versatile Disk) with the optical disc reproduction apparatus, and output video and audio corresponding to such signals from video display unit and speaker of the television receiver, respectively, and is capable to obtain audio signal by reproducing CD (Compact Disc), and output audio corresponding to the audio signal from the speaker of the television receiver, has been known.

In addition, concerning an audio apparatus that can reproduce DVD and CD, an audio apparatus that prevents the audio apparatus from automatically reproducing DVD, according to a reproduction instructing information included in TOC (Table Of Contents) information which is recorded in the DVD loaded on a disc tray, has been known. Such audio apparatus can suppress power consumption due to unnecessary reproduction operation. (For example, refer to Japanese Patent Application Laid-Open No. 2004-220706, hereinafter referred to as patent document 1.)

Further, a video output circuit that can suppress power consumption by conducting current amplification in place of voltage amplification, thus lowering operation voltage of the circuit power to low voltage, has been known. (For example, refer to Japanese Patent Application Tokukaihei 11-225305, hereinafter referred to as patent document 2.)

An audio system that can determine ON/OFF status of an external device connected to the audio system, and conducts control of ON/OFF status of power of the audio system so as to correspond with the determined ON/OFF status of the external device, has been known. With such audio system, operation of a user is simplified, as well as power consumption in a state that the external device does not operate can be suppressed. (For example, refer to Japanese Patent Application Tokukaihei 9-91872, hereinafter referred to as patent document 3.)

A recording medium reproducing apparatus that suppress power consumption at an audio amplifier circuit by cutting off power supply route in accordance with detection of operation of pause being conducted at an operation unit, has been known. (For example, refer to Japanese Patent Application Laid-Open No. 2000-67519, hereinafter referred to as patent document 4.)

Concerning a composite AV apparatus that has a plurality of kinds of devices such as television, video, CD player, tape recorder, and the like, in one cabinet, a composite AV apparatus that aims electric power saving has been known. In such composite AV apparatus, when an operation button of remote is operated to select a device desired by a user, and it is switched so that the selected device is operated, power of other devices are shut down, thus electric power saving is achieved. (For example, refer to Japanese Patent Application Tokukaihei 7-288874, hereinafter referred to as patent document 5.)

### SUMMARY OF THE INVENTION

However, in the case of television receiver with optical disc reproduction apparatus of the aforementioned conventional techniques, video display unit is operated even when CD is reproduced at the optical disc reproduction apparatus of the television receiver, and audio is outputted from the speaker. Therefore, there was a problem that unnecessary power was consumed by the video display unit even when there is no video signal and display of video is not conducted at the video display unit (for example, stand-by state such as black screen display).

In addition, with the techniques relating to suppression of power consumption disclosed in the aforementioned patent documents 1 through 5, the aforementioned problem concerning television receiver with optical disc reproduction apparatus was not solved.

An object of the present invention is to provide a video display device with optical disc reproduction apparatus and a television receiver with optical disc reproduction apparatus, that can suppress unnecessary operation of the video display unit, and suppress power consumption.

According to one aspect of the present invention, a television receiver with optical disc reproduction apparatus comprises: a receiving unit to receive a broadcast signal that relates to a predetermined broadcast; an optical disc reproduction apparatus that is capable to reproduce video data and audio data recorded in an optical disc for video and audio, and to reproduce audio data recorded in an optical disc for audio; a video display unit to display video according to video data that corresponds to the broadcast signal received by the receiving unit or video data reproduced by the optical disc reproduction apparatus; an audio output unit to output audio according to audio data that corresponds to the broadcast signal received by the receiving unit or audio data reproduced by the optical disc reproduction apparatus; a switching section comprising a transistor whose collector side is connected to a power source within a driving circuit to operate the video display unit, and a switching unit that is connected to a base side of the transistor and is capable to switch ON/OFF; and an optical disc determination section to determine whether an optical disc loaded on the optical disc reproduction apparatus is the optical disc for audio or not; wherein in a case where it is determined by the optical disc determination section that the optical disc loaded on the optical disc reproduction apparatus is the optical disc for audio, current supplied to from the power source to the video display unit is cut off by switching the switching unit of the switching section to OFF.

According to the invention, the television receiver with optical disc reproduction apparatus can display video according to the video data that corresponds to the broadcast signal received by the receiving unit on the video display unit, and output audio according to the audio data from the audio output unit.

In addition, the television receiver with optical disc reproduction apparatus can reproduce video data and audio data that are recorded in the optical disc for video and audio by the optical disc reproduction apparatus, display video according to the video data on the video display unit, and output audio according to the audio data from the audio output unit. Further, audio data recorded in the optical disc for audio can be reproduced by the optical disc reproduction apparatus, and the audio according to the audio data can be outputted from the audio output unit.

The television receiver with optical disc reproduction apparatus can determine whether the optical disc loaded on the optical disc reproduction apparatus is the optical disc for audio or not. In a case where it is determined that the optical disc is the optical disc for audio, the television receiver with optical disc reproduction apparatus can switch so as to cut off current supplied from the power source to the video display unit by the switching section.

That is, the television receiver with optical disc reproduction apparatus cuts off current supplied to the video display unit which does not need to be operated, when conducting reproduction processing of the optical disc for audio. Therefore, operation of the video display unit can be terminated, and power consumed by the video display unit can be suppressed.

In particular, the switching section of the television receiver with optical disc reproduction apparatus is provided with a transistor whose collector side is connected to a power source within a driving circuit to operate the video display unit, and a switching unit that is connected to a base side of the transistor and is capable to switch ON/OFF. In a case where it its determined that the optical disc loaded on the optical disc reproduction apparatus is the optical disc for audio, the switching section can be switched to OFF so that base current of the transistor does not flow, by switching the switching unit to OFF. Thus, when the base current of the transistor is switched to OFF, the transistor itself becomes an OFF state, and current does not flow from the collector side to the emitter side of the transistor. Therefore, since current supplied from the power source connected to the collector side of the transistor to the driving circuit through the transistor is cut off, power consumed at the video display unit can be suppressed.

Therefore, when conducting reproduction processing of the optical disc for audio by the television receiver with optical disc reproduction apparatus, current supplied to the video display unit that does not need to be operated can be cut of by a simple circuit structure. Therefore, operation of the video display unit can be terminated suitably, thus power consumed at the video display unit can be suppressed.

As a result, the television receiver with optical disc reproduction apparatus can suppress unneeded operation of the video display unit, and decrease power consumption.

According to a second aspect of the present invention, a video display device with optical disc reproduction apparatus comprises: an optical disc reproduction apparatus that is capable to reproduce video data and audio data recorded in an optical disc for video and audio, and to reproduce audio data recorded in an optical disc for audio; a video display unit to display video according to video data reproduced by the optical disc reproduction apparatus; an audio output unit to output audio according to audio data reproduced by the optical disc reproduction apparatus; an optical disc determination section to determine whether an optical disc loaded on the optical disc reproduction apparatus is the optical disc for audio or not; and a switching section to switch so as to cut off current supplied from a power source to the video display unit in a case where it is determined by the optical disc determination section that the optical disc loaded on the optical disc reproduction apparatus is the optical disc for audio.

According to the above invention, the video display device with optical disc reproduction apparatus can reproduce video data and audio data that are recorded in the optical disc for video and audio by the optical disc reproduction apparatus, display video according to the video data on the video display unit, and output audio according to the audio data from the audio output unit. Further, audio data recorded in the optical disc for audio can be reproduced by the optical disc reproduction apparatus, and the audio according to the audio data can be outputted from the audio output unit.

The video display device with optical disc reproduction apparatus can determine whether the optical disc loaded on the optical disc reproduction apparatus is the optical disc for audio or not. In a case where it is determined that the optical disc is the optical disc for audio, the video display device with optical disc reproduction apparatus can switch so as to cut off current supplied from the power source to the video display unit by the switching section.

That is, the video display device with optical disc reproduction apparatus cuts off current supplied to the video display unit which does not need to be operated, when conducting reproduction processing of the optical disc for audio. Therefore, operation of the video display unit can be terminated, and power consumed by the video display unit can be suppressed.

As a result, the video display device with optical disc reproduction apparatus can suppress unneeded operation of the video display unit, and decrease power consumption.

Preferably, the switching section comprises a transistor whose collector side is connected to the power source within a driving circuit to operate the video display unit, and a switching unit that is connected to a base side of the transistor and is capable to switch ON/OFF; and current supplied to from the power source to the video display unit is cut off by switching the switching unit to OFF, in a case where it is determined by the optical disc determination section that the optical disc loaded on the optical disc reproduction apparatus is the optical disc for audio.

According to the above invention, the same effect as the invention previously described can be obtained as a matter of course. In addition, the switching section of the video display device with optical disc reproduction apparatus is provided with a transistor whose collector side is connected to a power source within a driving circuit to operate the video display unit, and a switching unit that is connected to a base side of the transistor and is capable to switch ON/OFF. In a case where it its determined that the optical disc loaded on the optical disc reproduction apparatus is the optical disc for audio, the switching section can be switched to OFF so that base current of the transistor does not flow, by switching the switching unit to OFF.

When the base current of the transistor is switched to OFF, the transistor itself becomes an OFF state, and current does not flow from the collector side to the emitter side of the transistor. Therefore, current supplied from the power source connected to the collector side of the transistor to the driving circuit through the transistor is cut off.

Therefore, when conducting reproduction processing of the optical disc for audio by the video display device with optical disc reproduction apparatus, current supplied to the video display unit that does not need to be operated can be cut off by a simple circuit structure.

### BRIEF DESCRIPTION OF THE DRAWINGS

The present invention will become more fully understood from the detailed description given hereinbelow and the accompanying drawings which are given by way of illustration only, and thus are not intended as a definition of the limits of the present invention, and wherein;

FIG. 1 is a block diagram showing principal structure of a television with DVD reproduction apparatus according to the present invention; and

FIG. 2 is a flowchart showing processing relating to operation of optical reproduction apparatus concerning the television with DVD reproduction apparatus.

### DETAILED DESCRIPTION OF THE PREFERRED EMBODIMENT

Hereinafter, detailed description of an embodiment of a video display device with optical disc reproduction apparatus according to the present invention is given with reference to the drawings. Here, in the present embodiment, a television receiver with optical disc reproduction apparatus (hereinafter referred to as television with DVD reproduction apparatus, or television) is taken as an example of the video display device with optical disc reproduction apparatus.

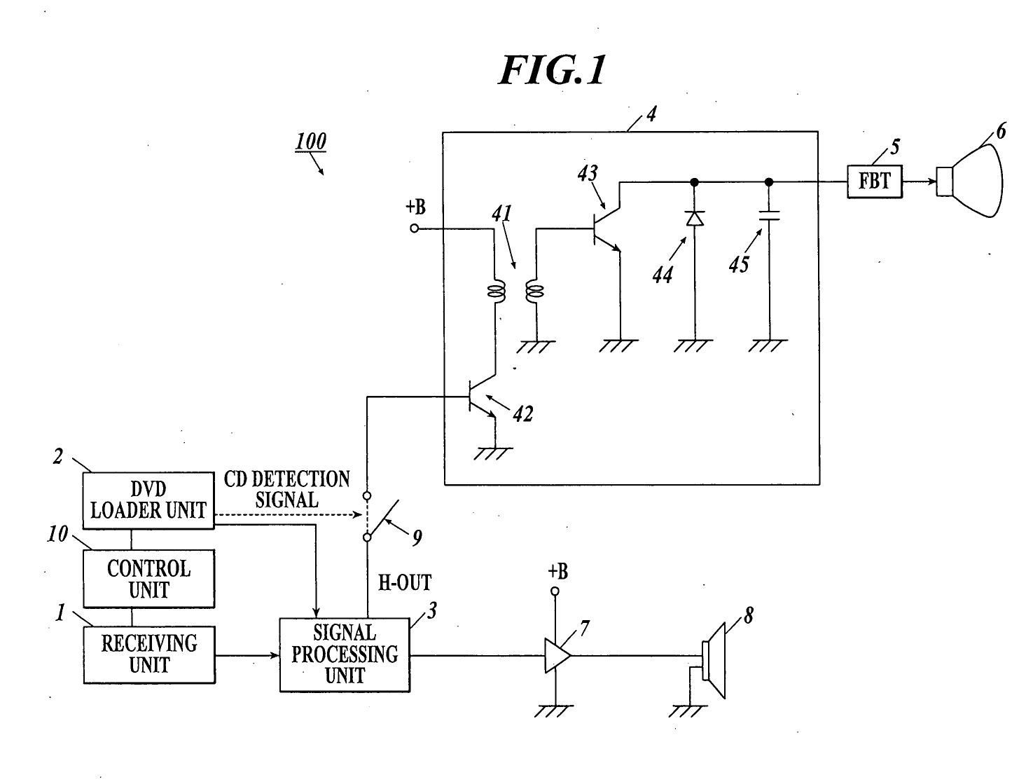

As shown in FIG. 1, television with DVD reproduction apparatus 100 is provided with a receiving unit 1 to receive broadcast signal broadcasted from broadcast station, an optical disc reproduction apparatus 2 to reproduce data recorded in optical disc which is a recording medium, a signal processing unit 3 to provide a predetermined processing relating to broadcast signal received by the receiving unit 1 and data reproduced by the optical disc reproduction apparatus 2, a Braun tube 6 as a video display unit that is connected to the signal processing unit 3 through video display driving circuit 4 and flyback transformer (FBT) 5, a speaker 8 as an audio output unit that is connected to the signal processing unit 3 through audio amplifier 7, a control unit 10 to control each unit of the television 100, and the like.

The receiving unit 1 is provided with antenna device, tuner, and the like, and receives a predetermined broadcast signal that corresponds to channel and the like selected at the television 100. Then, the received broadcast signal is sent to the signal processing unit 3. Here, video signal and audio signal relating to a broadcast program is included in the broadcast signal.

The optical reproduction apparatus 2 is a DVD player (DVD loader unit) that can apply reproduction processing to DVD which is an optical disc for video/audio, and reproduce video data and audio data recorded in the DVD. In addition, the optical disc reproduction apparatus 2 can also apply reproduction processing to CD which is an optical disc for audio, and reproduce audio data recorded in the CD. Then, the optical disc reproduction apparatus 2 sends video signal and audio signal that correspond to reproduced video data and audio data to the signal processing unit 3.

Further, the optical disc reproduction apparatus 2 reads TOC information recorded in the inner circumference of DVD and CD that are loaded on the disk tray, and outputs the read TOC information to the control unit 10. Here, number of tracks to which contents is recorded, recording time of each track, start address and end address of each track, type of data recorded in each track, and the like are included in the TOC information.

The signal processing unit 3 applies a predetermined processing to the broadcast signal received by the receiving unit 1, and video signal and audio signal reproduced by the optical disc reproduction apparatus 2, and converts them into electric signal. Subsequently, the signal processing unit 3 sends electric signal (horizontal synchronization signal for example) relating to video, which was processed to display video on the Braun tube 6, to the video display driving circuit 4, and sends electric signal relating to audio, which was processed to output audio from the speaker 8, to audio amplifier 7.

The video display driving circuit 4 is a horizontal deflection circuit, for example, and is provided with a transformer 41 that is connected to the power source (+B), a first transistor 42 that serves as a part of a switching section that is connected to primal side of the transformer 41, a second transistor 43 that is connected to secondary side of the transformer 41, a diode 44, a condenser 45, and the like. The video display driving circuit 4 conducts deflection processing of scanning line and the like to the inputted video signal (horizontal synchronization signal), and outputs signal relating to the video to the Braun tube 6 through the flyback transformer 5.

Here, to the collector side of the first transistor 42, the power source (+B) is connected through the transformer 41.

In addition, in between the signal processing unit 3 and the video display driving circuit 4, a switch 9 that serves as a part of switching section is arranged.

The switch 9 is a switching section that can switch ON/OFF relating to the connection between the signal processing unit 3 and the video display driving circuit 4, and is capable to transfer electric signal (video signal) sent to the video display driving circuit 4 from the signal processing unit 3, and to switch the cutoff (ON/OFF).

Here, the switch 9 is connected to base side of the first transistor 42.

Then, with the result obtained by the TOC information of the optical disc being read by the optical disc reproduction apparatus 2, in a case where it is determined, by the control processing of the control unit 10 (optical disc determination section) described later, that optical disc loaded on the disk tray of the optical disc reproduction apparatus 2 is CD, the switch 9 is switched to OFF according to the CD detection signal outputted from the optical disc reproduction apparatus 2.

When the switch 9 is switched to OFF, and electric signal relating to video which is inputted to the video display driving circuit 4 from the signal processing unit 3 is cutoff, base current of the first transistor 42 does not flow, and is switched OFF.

When the base current of the first transistor 42 is switched OFF, the first transistor 42 itself becomes OFF, and thus current does not flow from the collector side to the emitter side of the first transistor 42. Therefore, current does not flow from the power source (+B) to the transformer 41, and power supply from the power source (+B) to the Braun tube 6 is cut off.

That is, by the switch 9 being switched OFF, current supply from the power source (+B) to the video display driving circuit 4, the flyback transformer 5, and the Braun tube 6 is cut off. Therefore, power consumption at the video display driving circuit 4, the flyback transformer 5, and the Braun tube 6 can be suppressed.

The Braun tube 6 is a video display device that outputs electron beam according to the inputted video signal, and forms video by exposing fluorescent screen of a tube surface (front surface) of the Braun tube 6 with the electron beam.

The audio amplifier 7 conducts amplification processing and the like to the inputted audio signal (electric signal), and outputs signal relating to audio to the speaker 8. In addition, power source (+B) is connected to the audio amplifier 7.

The speaker 8 is a device that outputs audio, by making a solenoid vibrate diaphragm for example, according to the inputted audio signal.

Here, the power source (+B) is connected to the audio amplifier 7 of audio output system, independently. Therefore, even in a case where the switch 9 is switched to OFF and power supply to video display system is cut off, the audio amplifier 7 and the speaker 8 can be operated, thus audio can be outputted.

The control unit 10 is provided with a CPU for example, and conducts centralized control of each unit, according to various kinds of control programs for television with DVD reproduction apparatus stored in ROM or the like not shown, in correspondence with an operation signal inputted from an operation unit of a remote not shown, a setting data that is set in advance, or the like. Then the result of processing is stored in a work area in the RAM not shown.

Then, the control unit 10 controls operation of each unit that structure the television with DVD reproduction apparatus 100, and executes broadcast of broadcast program according to broadcast signal, broadcast of contents such as a movie recorded in the DVD, and reproduction of music recorded in the CD.

In addition, the control unit 10 serves as an optical disc determination section to determine whether an optical disc loaded on the disc tray of the optical disc reproduction apparatus 2 is CD or not.

Here, the control unit 10 as the optical disc determination section determines whether it is a CD or not, by determining whether the optical disc loaded on the optical disc reproduction apparatus 2 is a DVD or a CD, according to the TOC information of the optical disc that is read by the optical disc reproduction apparatus 2.

In a case where the control unit 10 as the optical disc determination section determines that the optical disc loaded on the optical disc reproduction apparatus 2 is CD, the control unit 10 executes a control to make the optical disc reproduction apparatus 2 output the CD detection signal to the switch 9, and executes processing to switch to OFF by opening the switch 9 so as to cut off.

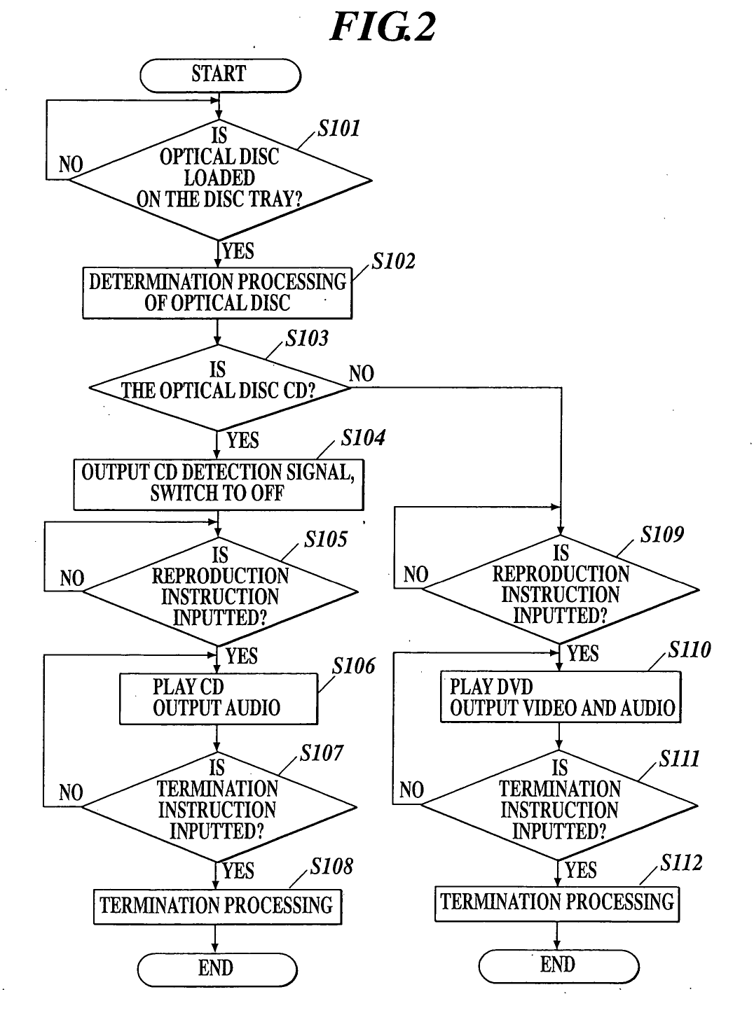

Next, a processing in which the television with DVD reproduction apparatus 100 according to the present invention switches the switch 9 to OFF is described with reference to flowchart of FIG. 2.

First of all, the control unit 10 of the television with DVD reproduction apparatus 100 determines whether an optical disc is loaded on the disc tray of the optical disc reproduction apparatus 2 (step S101).

In a case where it is determined that optical disc is not loaded on the disc tray of the optical disc reproduction apparatus 2 (step S101; No), it stands by until an optical disc is loaded, or moves onto processing relating to broadcast signal received by the receiving unit 1.

On the other hand, in a case where the control unit 10 determines that optical disc is loaded on the disc tray of the optical disc reproduction apparatus 2 (step S101; Yes), the control unit 10 executes a determination processing to determine the type of optical disc that is loaded (step S102).

In a case where the control unit 10 determines that the optical disc that is loaded on the disc tray of the optical disc reproduction apparatus 2 is CD, according to the TOC information or the like that is recorded on the optical disc (step S103; Yes), it moves on to step S104.

On the other hand, in a case where the control unit 10 determines that the optical disc that is loaded on the disc tray of the optical disc reproduction apparatus 2 is DVD and not CD, according to the TOC information or the like that is recorded on the optical disc (step S103; No), it moves on to step S109.

In step S104, the control unit 10 makes the optical disc reproduction apparatus 2 output the CD detection signal to the switch 9, and switches the switch 9 to OFF (step S104).

Then, when the control unit 10 detects that a reproduction instruction of CD (optical disc) has been inputted (step S105; Yes), corresponding to the operation unit such as remote being operated by a user, the optical disc reproduction apparatus 2 is operated (CD is played), and audio is outputted from the speaker 8 of the television with DVD reproduction apparatus 100 (step S106).

Here, in step S104, since the switch 9 is switched to OFF, current supply from the power source (+B) to the Braun tube 6 is cut off, thus power consumption relating to video display during reproduction of CD is suppressed.

When the control unit 10 detects a termination instruction relating to reproduction of CD is inputted (step S107; Yes), corresponding to the operation unit such as remote being operated by a user, the control unit 10 terminates the operation of the optical disc reproduction apparatus 2 (step S108), and terminates the processing of CD reproduction.

In step S109, when the control unit 10 detects that a reproduction instruction of DVD (optical disc) has been inputted (step S109; Yes), corresponding to the operation unit such as remote being operated by a user, the optical disc reproduction apparatus 2 is operated (DVD is played), and contents (video and audio) recorded in the DVD is reproduced and outputted at the television with DVD reproduction apparatus 100 (step S110).

When the control unit 10 detects a termination instruction relating to reproduction of DVD is inputted (step S111; Yes), corresponding to the operation unit such as remote being operated by a user, the control unit 10 terminates the operation of the optical disc reproduction apparatus 2 (step S112), and terminates the processing of DVD reproduction.

As described above, the television with DVD reproduction apparatus 100 according to the present invention can cut off current that is supplied from the power source (+B) to the video display driving circuit 4, the flyback transformer 5, and the Braun tube 6, in a case where it is determined that the optical disc loaded on the disc tray of the optical disc reproduction apparatus 2 is CD. This is achieved by outputting CD detection signal and switching the switch 9 to OFF.

Therefore, when reproduction processing of CD is conducted at the optical disc reproduction apparatus 2 of the television with DVD reproduction apparatus 100, operation of video display system (the video display driving circuit 4, the flyback transformer 5, and the Braun tube 6) that does not need to be operated, can be terminated. Therefore, power consumption at the video display system such as the Braun tube 6 can be suppressed.

That is, the television with DVD reproduction apparatus 100 is a video display device with optical disc reproduction apparatus (television receiver) that can suppress operation of video display system such as the Braun tube 6, which is not needed when reproduction of CD is conducted, and only audio is outputted. Therefore, power consumption is suppressed.

Here, in the aforementioned embodiment, the Braun tube 6 was given as an example of video display unit, however, the present invention is not limited to this case. For example, the video display unit may be an LCD (Liquid Crystal Display), a PDP (Plasma Display Panel), or the like. In addition, in such case, the video display driving circuit 4 should be a driving circuit that corresponds to the video display unit.

In addition, in the aforementioned embodiment, the video display driving circuit 4 which is a horizontal deflection circuit was given as an example of the driving circuit. However, the present invention is not limited to this case, and the driving circuit may be a vertical deflection circuit.

Further, in the aforementioned embodiment, power consumption was suppressed by cutting off the current supplied from the power source (+B) to the video display driving circuit 4, by switching the switch 9 to OFF. However, the present invention is not limited to this case. For example, cut off of current may be conducted to the deflecting yoke provided to the video display driving circuit 4.

In the aforementioned embodiment, current supplied from the power source (+B) to the video display driving circuit 4 was cut off by cooperation of the switch 9 and the first transistor 42 as the switching section. However, the present invention is not limited to this case. For example, current supplied from the power source to a predetermined video display unit and various units of the video display system may be cut off directly by switching one switch to OFF, or the switching section may have any other arbitrary structure.

In addition, the video display device with optical disc reproduction apparatus is not limited to the television receiver, and may be a monitor apparatus or the like that can output video and audio.

Further, other detail structure and the like can be modified arbitrarily as a matter of course.

The entire disclosure of Japanese Patent Application No. Tokugan 2005-319223 filed on Nov. 2, 2005 including specification, claims, drawings and summary are incorporated herein by reference in its entirety.

What is claimed is:

1. A television receiver with optical disc reproduction apparatus comprising:
a receiving unit to receive a broadcast signal that relates to a predetermined broadcast;
an optical disc reproduction apparatus that is capable to reproduce video data and audio data recorded in an optical disc for video and audio, and to reproduce audio data recorded in an optical disc for audio;
a video display unit to display video according to video data that corresponds to the broadcast signal received by the receiving unit or video data reproduced by the optical disc reproduction apparatus;
an audio output unit to output audio according to audio data that corresponds to the broadcast signal received by the receiving unit or audio data reproduced by the optical disc reproduction apparatus;
a switching section comprising a transistor whose collector side is connected to a power source within a driving circuit to operate the video display unit, and a switching unit that is connected to a base side of the transistor and is capable to switch ON/OFF; and
an optical disc determination section to determine whether an optical disc loaded on the optical disc reproduction apparatus is the optical disc for audio or not;
wherein in a case where it is determined by the optical disc determination section that the optical disc loaded on the optical disc reproduction apparatus is the optical disc for audio, current supplied to from the power source to the video display unit is cut off by switching the switching unit of the switching section to OFF.

2. A video display device with optical disc reproduction apparatus comprising:
an optical disc reproduction apparatus that is capable to reproduce video data and audio data recorded in an optical disc for video and audio, and to reproduce audio data recorded in an optical disc for audio;
a video display unit to display video according to video data reproduced by the optical disc reproduction apparatus;
an audio output unit to output audio according to audio data reproduced by the optical disc reproduction apparatus;
an optical disc determination section to determine whether an optical disc loaded on the optical disc reproduction apparatus is the optical disc for audio or not; and
a switching section to switch so as to cut off current supplied from a power source to the video display unit in a case where it is determined by the optical disc determination section that the optical disc loaded on the optical disc reproduction apparatus is the optical disc for audio.

3. The video display device with optical disc reproduction apparatus as claimed in claim 2, wherein:
the switching section comprises a transistor whose collector side is connected to the power source within a driving circuit to operate the video display unit, and a switching unit that is connected to a base side of the transistor and is capable to switch ON/OFF; and
current supplied to from the power source to the video display unit is cut off by switching the switching unit to OFF, in a case where it is determined by the optical disc determination section that the optical disc loaded on the optical disc reproduction apparatus is the optical disc for audio.
